(19) United States
(12) Patent Application Publication
(10) Pub. No.: US 2016/0328419 A1
(43) Pub. Date: Nov. 10, 2016

(54) SYSTEM FOR DETERMINATION OF A FIELD ROCK TYPE

(71) Applicant: Schlumberger Technology Corporation, Sugar Land, TX (US)

(72) Inventors: Sergey Sergeevich Safonov, Moscow (RU); Denis Vladimirovich Klemin, Houston, TX (US); Dimitriy Vyacheslavovich Dozhdev, Tula (RU)

(21) Appl. No.: 15/108,169

(22) PCT Filed: Dec. 25, 2013
(86) PCT No.: PCT/RU2013/001167

§ 371 Date: Jun. 24, 2016

(51) Int. Cl. G06F 17/30; E21B 49/02; E21B 49/08

(52) U.S. Cl. CPC G06F 17/30241; G06F 17/30312; G06F 17/30345; G06F 17/3028; E21B 49/08; E21B 49/02

(57) ABSTRACT

A system for determination of a field rock type comprises a computer processor and a rock typing tool executing on the computer processor. The rock typing tool comprises a rock property database configured to store rock property data, a first module configured to receive new input field rock property data and a data processing module configured to characterize the new input field rock property data and to determine field rock type as a best matched rock type.

### FIELD OF THE DISCLOSURE

The invention relates to a computer-base information system for determining field rock types and displaying, searching, manipulating and modifying rock property data.

### BACKGROUND OF THE DISCLOSURE

In order to qualitatively determine where to drill wells, how to complete them, how efficiently wells are producing, and when they are depleted it is crucial to effectively couple information obtained from reservoir fluid samples, pressure/temperature data, and information about the volumetric extent of the reservoir together with rock property data obtained from logs and core studies done in lab and digitally using numerical solvers. Rock typing is one of the main difficulties and a main source of uncertainty in a reservoir modeling. In oil and gas industry there is a need for a methodology and system provided automated rock typing based on the rock property data. Rock property data directly influence on estimation of reserves, estimation of recoverable oil and gas, possible production rates, and field recovery economics. One of the main difficulties when working with rock property data is to correctly determine field rock types. Careful setup of the rock types typical for the given field will reduce the reservoir simulation input data uncertainty range and improve the accuracy of the resultant output.

U.S. Pat. No. 6,516,080 describes a numerical method of estimating a desired physical property of a three-dimensional porous medium including fluid flow properties, electrical properties, elastic properties, permeability, electrical conductivity, and elastic wave velocity. According to this method a three-dimensional model is reconstructed from experimental two-dimensional images by statistical means; properties are calculated using a numerical solver of Navier-Stokes equations, or a Lattice-Boltzmann flow simulator, or any finite element numerical solver. This patent doesn't directed to set a correlation between structure of studied core sample and field rock types therefore obtained physical parameters (fluid flow properties, electrical properties, elastic properties, permeability, electrical conductivity) cannot be used directly in reservoir modeling.

US patent 20110035346 describes a system for analyzing and synthesizing a plurality of sources of sample data by automated learning and regression. The system includes data storage with a stored multi-task covariance function, and an evaluation processor in communication with the data storage. The evaluation processor performs regression using the stored sample data and multi-task covariance function and synthesizes prediction data for use in graphical display or digital control. This invention is limited with usage of mathematical technique based on regression using the Gaussian process (GP) and aimed to synthesis of macro scale models for mining, environmental sciences, hydrology, economics and robotics purposes only.

### SUMMARY OF THE DISCLOSURE

In accordance with the present invention a system for determination of a field rock type comprises a computer processor and a rock typing tool executing on the computer processor. The rock typing tool comprises a rock property database configured to store rock property data, a first module configured to receive new input field rock property data and a data processing module configured to characterize the new input field rock property data and to determine at least one field rock type as a best matched rock type. Rock type classification is based on the analysis of the rock property data.

The rock property data stored in a rock property database comprises digital rock data, digital rock property data, reservoir fluid analysis data, data from core lab experiments, well logging data, a core origin context, a core geological context.

The digital rock data comprise at least one of the group consisting of digital core images of rock samples, results of mineral mapping in the rock samples, results of representative elementary volume analysis of the rock samples, results of microporosity analysis, results of wettability mapping in the rock samples, results of microstructural and heterogeneity analysis by NMR/MRI, results of geomechanical analysis.

The digital rock property data comprise data obtained from numerical simulations of rock properties using three-dimensional digital core images of the rock samples.

The data from core lab experiments comprise results of routine core analysis and results of special core analysis.

The well logging data comprise well testing data and petrophysical reservoir characterization.

The core origin context comprises information on core owner, country, field, well, depth, core orientation and length.

The core geological context comprises information on formation type, lithological description.

The sets of digital core images can be obtained by X-ray microtomography, by 3D NMR imaging, by the reconstruction from petrographic thin-section analysis, via the FIB-SEM.

In one of the embodiments the system can comprise a third module providing navigation, data search and browsing in the rock property database.

The first module of the system can be integrated with numerical solvers and can be configured to obtain digital rock property data either automatically and/or manually.

In accordance with yet another aspect of the present invention the data processing module of the system could be configured to update existing and/or add the new rock types either automatically or manually.

In accordance with one embodiment the third module of the system can be configured to provide a graphic representation of the data stored in the database to be displayed on a computer display device.

In accordance with another aspect of the present invention the third module of the system is configured to create reports on core analysis, data statistic, core model preview, core lab experiments and well testing.

### BRIEF DESCRIPTION OF THE DRAWINGS

FIG. 1 shows a schematic diagram of a system in accordance with one or more embodiments.

FIG. 2 shows a greyscale 2D slice of 3D microCT images of 8 mm miniplug

FIG. 3 shows relative permeability curves for the digital rock model of the Berea sandstone core sample at different flow regimes.

### DETAILED DESCRIPTION

Specific embodiments will now be described in detail with reference to the accompanying figures.

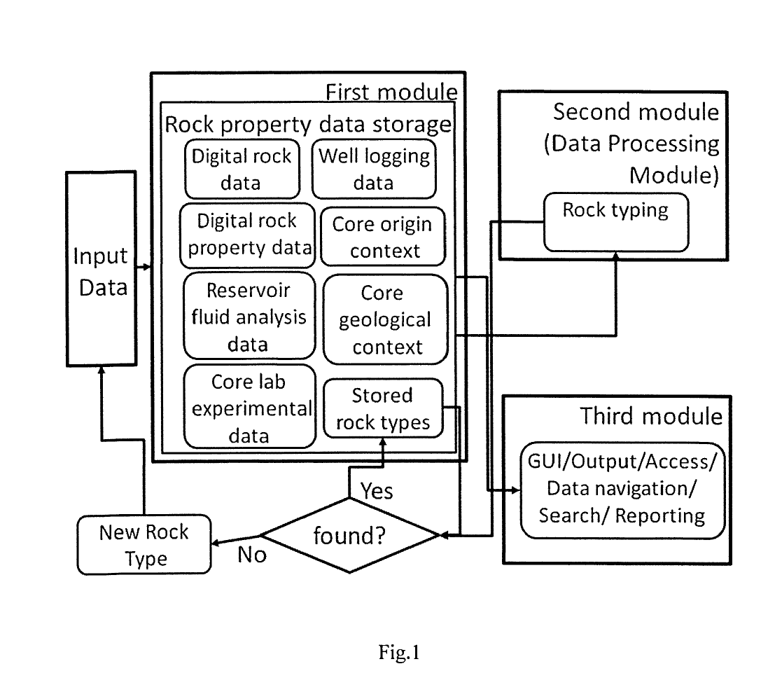

In general, embodiments provide a system for rock typing based on a rock property data. FIG. 1 shows a schematic diagram of the system. The system uses a computer processor and a rock typing tool executing on the computer processor. The rock typing tool comprises rock property relational database that stores rock property data including but not limited with digital rock data—digital representation of core sample structure and surface properties, digital rock property data—data obtained from numerical simulations of rock properties on digital core images (set of 2D images comprising information on location of pores and rock skeleton), reservoir fluid analysis data, data from core lab experiments, well logging data, core origin context (customer, country, field, well, depth, core orientation and length), core geological context (formation, lithology, description).

The system comprises a first module configured to receive new input field rock property data, additional types of rock properties, new data types, and new digital rock property data—an interface to the computer-readable rock property relational database.

The data from core lab experiments comprise results of routine core analysis and results of special core analysis. The well logs data comprise well testing data and petrophysical reservoir characterization. The digital rock data could comprise a set of digital core images of rock samples, results of mineral mapping in the rock samples, results of representative elementary volume analysis of the rock samples, results of microporosity analysis, results of wettability mapping in the rock samples, results of microstructural and heterogeneity analysis by NMR/MRI, results of geomechanical analysis. Digital core images could be obtained via the X-ray microtomography, and/or by 3D NMR imaging or reconstructed using the petrographic thin-section analysis data and/or SEM data optionally with the application of image analysis techniques for binarization of the greyscaled or colored 2D slices.

In one of the embodiments the proposed system is integrated with numerical micro-hydrodynamic solvers, for example, with direct hydrodynamic modeling software described in A. Demianov, O. Dinariev and N. Evseev, Density functional modelling in multiphase compositional hydrodynamics, Can. J. Chem. Eng., 89, pp. 206-226, 2011.

By using the above described digital rock data together with reservoir fluids analysis data stored in the database and the integrated numerical solvers the digital rock property data could be obtained either automatically and/or manually and supplement core lab experimental data inside the rock property database. Digital rock properties include but not limited with routine core analysis data (porosity, absolute permeability), special core analysis data (2-, 3-phase relative permeabilities, desaturation curves, capillary pressure curves) and petrophysical property analysis data (thermal, NMR, electric and acoustic properties).

All this rock property data is stored in the database and then characterized using the data processing module (second module). In one of the embodiments the module operational workflow could comprise following steps:
Rock structure analysis using image analysis and/or pattern recognition techniques for digital core images, core and thin section photography data. Output of the analysis includes but not limited with porosity, cementation, grain size distributions, pore shape description, pore connectivity graphs, mineralogy, clay distribution etc.
Well logging data and/or digital core properties data and/or core lab data categorization and grouping (using in one of the embodiments the cluster analysis and/or principal component analysis and/or regression analysis and/or artificial neural network analysis). At this step the data is grouped and in one of the embodiments the initial set of variables is transformed into a set of linearly uncorrelated values to reduce the number of variables for further analysis.
Defined data groups are then processed using the clustering algorithms (in one of the embodiments using the k-means clustering and/or k-nearest neighbors and/or hierarchical clustering) to define the prototype of each cluster.
In one of the embodiments grouping process and clustering analysis can be controlled by the system user. User can provide the data quality check and define the number of clusters needed for the data classification.
Selected clusters prototypes are then correlated with the matching rock structure analysis results
Using the mathematical optimization algorithms (in one of the embodiments using the simplex algorithm or iterative methods) selected data clusters prototypes together with the matched rock structure characteristics are compared with already stored data from database and the best matched rock type/types is selected. If the close match cannot be found in the list of already existed rock type data processing module synthesize a new rock type and add it to the database. System could also support manual input of new rock types for the purposes of machine learning.

A system could also comprise a third module providing navigation, data search and browsing in the rock property relational database. In one of the embodiments of the disclosed system the third module could be used to create reports on core analysis, data statistic, provide a core model preview, core lab experimental data and well testing data using the already stored data from relational data base and provide a graphic representation of the data stored in the database to be displayed on a computer display device.

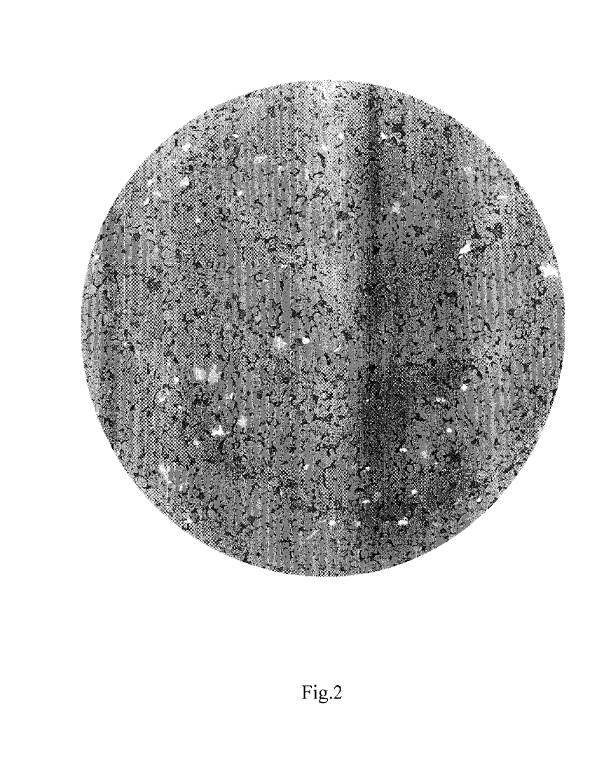

System disclosed in the invention was used for field rock type determination of the Berea sample core plugs. Berea sandstone samples are composed of grains of quartz bonded by silica and described as the sedimentary rocks with sand-size grains. 8 mm plugs were drilled from cylindrical core samples of standard size and scanned using the X-ray microtomography with 2.2 um/pix scanning resolution, representation of the reconstructed 2D slice presented on the FIG. 2.

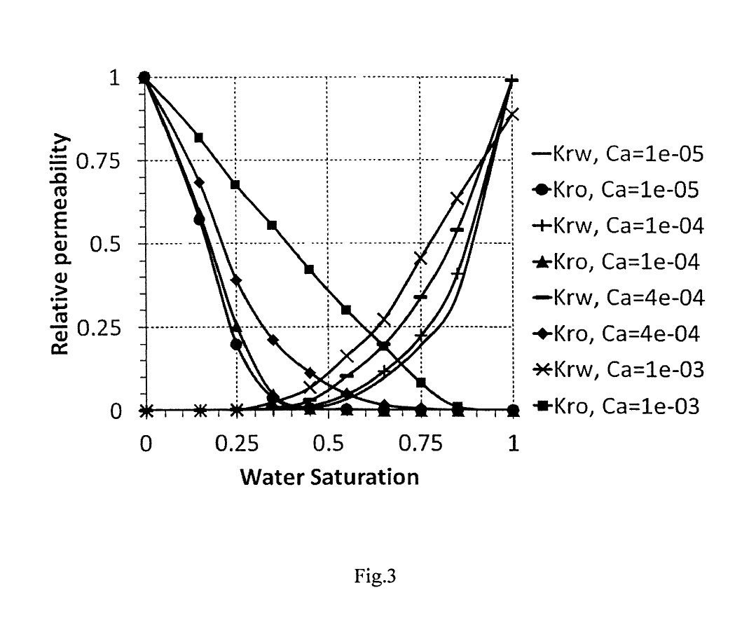

Core lab measurements were done on the samples of standard size and on the sample of 8 mm size: lab porosity was equal to 20.1%; absolute permeability measured with gas 100 mD. Digital rock properties were obtained on digital rock model of 8 mm plug (with the resolution of 2.2 um/pix), fraction of microCT resolved voids (connected porosity of digital rock model) was equal to 14.3%, numerically simulated absolute permeability was equal to 125.6 mD. Relative permeabilities, simulated using direct hydrodynamic modeling software for 8 mm core plug are presented on FIG. 3.

Rock property data for both 30 mm and 8 mm core plugs and the digital rock property data for 8 mm plugs were stored in a rock property relational database. Data Processing Module was used to determining the best fitted field rock type:
Rock structure analysis using image analysis on digital core images, core and thin section photography data was done. Result: core plugs predominately consists of silica, average pore body size is 26 micrometers, average pore throat size is 14 micrometers, grain diameter was estimated to be in range from 70 to 315 micrometers. Pore and throat shape factors distributions were constructed, fraction of ellipsoidal grains were estimated to be equal to 0.23. Clay content was measured to be equal to 0.08 (volume fraction).
Digital core properties data and core lab data were grouped using the cluster analysis.
Defined data groups were processed using the clustering algorithms, cluster prototypes were constructed
Clustering data was matched with the rock structure analysis results. Analysis showed that all stored data were distributed within one group based on the core absolute permeability and relative permeability data.
Using the simplex algorithm grouped rock properties data were compared with already stored data from database and as the result the data processing module classified both samples as “sandstone sample with clay content, porosity range of 15-25% and permeability range of 80-200 mD”.

Embodiments may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments.

While the above has been described with respect to a limited number of embodiments, those skilled in the art, having benefit of this disclosure, will appreciate that other embodiments can be devised which do not depart from the scope as disclosed herein. Accordingly, the scope should be limited by the attached claims.

1. A system for determination of a field rock type comprising:
a computer processor, and
a rock typing tool executing on the computer processor and comprising:
a rock property database configured to store rock property data,
a first module configured to receive new input field rock property data,
a data processing module configured to characterize the new input field rock property data and to determine field rock type as a best matched rock type.

2. The system of claim 1 wherein the rock property data stored in the rock property database comprises digital rock data, digital rock property data, reservoir fluid analysis data, data from core lab experiments, well logging data, a core origin context, a core geological context.

3. The system of claim 2 wherein the digital rock data comprise at least one of the group consisting of: digital core images of rock samples, results of mineral mapping in the rock samples, results of representative elementary volume analysis of the rock samples, results of microporosity analysis, results of wettability mapping in the rock samples, results of microstructural and heterogeneity analysis by NMR/MRI, results of geomechanical analysis.

4. The system of claim 2 wherein the digital rock property data comprise data obtained from numerical simulations of rock properties using three-dimensional digital core images of the rock samples.

5. The system of claim 2 wherein the data from core lab experiments comprise results of routine core analysis and results of special core analysis.

6. The system of claim 2 wherein the well logging data comprise well testing data and petrophysical reservoir characterization data.

7. The system of claim 2 wherein the core origin context comprises information on core owner, country, field, well, depth, core orientation and length.

8. The system of claim 2 wherein the core geological context comprises information on formation type, lithological description.

9. The system of claim 2 wherein the three-dimensional digital core images are obtained by X-ray microtomography.

10. The system of claim 2 wherein the three-dimensional digital core images are obtained by 3D NMR imaging.

11. The system of claim 2 wherein the three-dimensional digital core images are obtained by 3D reconstruction from petrographic thin-section analysis.

12. The system of claim 1 wherein the first module of the system is integrated with numerical solvers.

13. The system of claim 1 wherein the data processing module of the system is configured to update existing and/or add the new rock types either automatically or manually.

14. The system of claim 1 comprising a third module providing navigation, data search and browsing in the rock property database.

15. The system of claim 14 wherein the third module is configured to provide a graphic representation of the data stored in the database to be displayed on a computer display device.

16. The system of claim 14 wherein the third module is configured to create reports on core analysis, data statistic, core model preview, core lab experiments and well testing.
